(19) United States
(12) Patent Application Publication
(10) Pub. No.: US 2012/0327140 A1
(43) Pub. Date: Dec. 27, 2012

(54) LIQUID CRYSTAL DISPLAY FOR REDUCING MOTION BLUR

(76) Inventors: Tzu-Ming Wu, New Taipei City (TW); Jhen-Shen Liao, Taoyuan County (TW); Yi-Nan Chu, Changhua County (TW)

(21) Appl. No.: 13/602,332

(22) Filed: Sep. 4, 2012

Related U.S. Application Data
(62) Division of application No. 12/552,277, filed on Sep. 1, 2009.

(30) Foreign Application Priority Data
May 20, 2009 (TW) 098116691

(51) Int. Cl. G09G 3/36; G09G 5/10

(52) U.S. Cl. 345/690; 345/89

(57) ABSTRACT

An LCD for reducing motion blur includes a display panel, a source driver, a gate driver, and a timing controller. The display panel includes a plurality of pixels for display an image data. The timing controller includes a timing control unit and a data processing unit. The timing control unit controls the timing of the image data outputting to the source driver and the gate driver. The data processing unit analyzes the image data so as to insert black gray-level for the different pixels of the plurality of pixels in the different frames.

### CROSS REFERENCE TO RELATED APPLICATIONS

This is a division of U.S. patent application Ser. No. 12/552,277, filed Sep. 1, 2009.

### BACKGROUND OF THE INVENTION

1. Field of the Invention

The present invention is related to a Liquid Crystal Display (LCD) DEVICE, and more particularly, to an LCD device for reducing motion blur.

2. Description of the Prior Art

The Cathode Ray Tube (CRT) display device utilizes hold-type display mechanism, which provides excellent visual quality for displaying dynamic frames. The LCD device utilizes impulse-type display mechanism and is prone to motion blur when the LCD device displays dynamic frames, due to the visual persistence characteristic of the human eyes.

The solution for improving the motion blur issue includes mainly three methods. The first method is to reduce the response time of the liquid crystals of the LCD device. The second method is to increase the edge enhancement of the displayed image. The third method is to alter the hold-type display mechanism of the LCD device. There are two ways to reduce the response time of the liquid crystals of the LCD device; utilizing the high speed liquid crystal material and Over-Drive (OD) mode. There are also two ways for altering the hold-type display mechanism; high speed driving (e.g. double speed frame rate) and simulated impulse-type display mechanism. Therefore overall there are mainly five methods for improving the motion blur issue when the LCD device displays dynamic frames.

Among the above-mentioned five methods for improving the motion blur issue, utilizing high speed liquid crystals requires replacing the LCD panel with new types of liquid crystals; OD mode requires an additional memory for recording the frame data; increasing the edge enhancement of the displayed image requires complex algorithms; high speed driving also requires an additional memory for recording the frame data to complete the dynamic interpolation of the frame data. Therefore, simulated impulse-type display mechanism is the most accessible method for reducing the motion blur when the LCD device displays dynamic frames.

The simulated impulse-type display mechanism can be divided into data control and backlight control. Due to the LED backlight of the small and medium sized panels utilizes side-lighting, it may be difficult for the panels to achieve regional control and the panels are prone to the issue of the flicker. Therefore adjusting backlight, relatively speaking, is not as practical as adjusting data; data control is more effective and efficient for solving the motion blur issue generated by the LCD device.

The conventional data control is performed according to timing, that is, a black frame is inserted in between two consecutive frames. The conventional data control, however, suffers the problem of the flicker in practical execution and high speed driving is required in collocation for preventing the flicker. As the frequency of the black frame being inserted gets lower, the higher the frame rate is required for preventing the flicker. Taking inserting a black frame into two consecutive 1/60 frames as an example, when a black frame is inserted into every two consecutive 1/60 frames, the frame rate required for preventing the flicker is increased to 120 Hz; when a black frame is inserted into every three consecutive 1/60 frames, the frame rate required for preventing the flicker is increased to 180 Hz.

### SUMMARY OF THE INVENTION

The present invention provides a liquid crystal display (LCD) device for reducing motion blur. The LCD comprises a display panel, a source driver, a gate driver, and a timing controller. The display panel comprises a plurality of pixels, for displaying an image data. The source driver is electrically connected to the display panel, for transmitting the image data. The gate driver is electrically connected to the display panel, for driving the plurality of pixels to display the image data. The timing controller comprises a timing controlling unit and a data processing unit. The timing controlling unit is used for controlling a timing of the image data to be outputted to the gate driver and the source driver. The data processing unit is used for analyzing the image data so as to insert a gray-level of black to different pixels of the plurality of pixels in different frames.

The present invention further provides a display method for reducing motion blur, comprising: providing a display panel which comprises a plurality of pixels, for displaying an image data; and analyzing the image data, for inserting a gray-level of black to different pixels of the plurality of pixels in different frames.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the Liquid Crystal Display (LCD) device for reducing motion blur of the present invention.

FIG. 2 is a diagram illustrating the generation of the gray-level according to the concept of visual persistence.

FIG. 3 is a diagram illustrating the generation of the gray-level according to the concept of visual averaged effect.

FIG. 4 is a diagram illustrating the LCD device inserts the gray-level according to the first embodiment of the present invention.

FIG. 5 is a diagram illustrating the LCD device inserts the gray-level according to the second embodiment of the present invention.

FIG. 6 is a diagram illustrating the LCD device inserts the gray-level according to the third embodiment of the present invention.

FIG. 7 is a diagram illustrating the LCD device with Dynamic Gamma Control (DGC) of the present invention.

FIG. 8 is a block diagram illustrating the DGC module.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . . ” Also, the term “electrically connect” is intended to mean either an indirect or direct electrical connection. Accordingly, if one device is coupled to another device, that connection maybe through a direct electrical connection, or through an indirect electrical connection via other devices and connections.

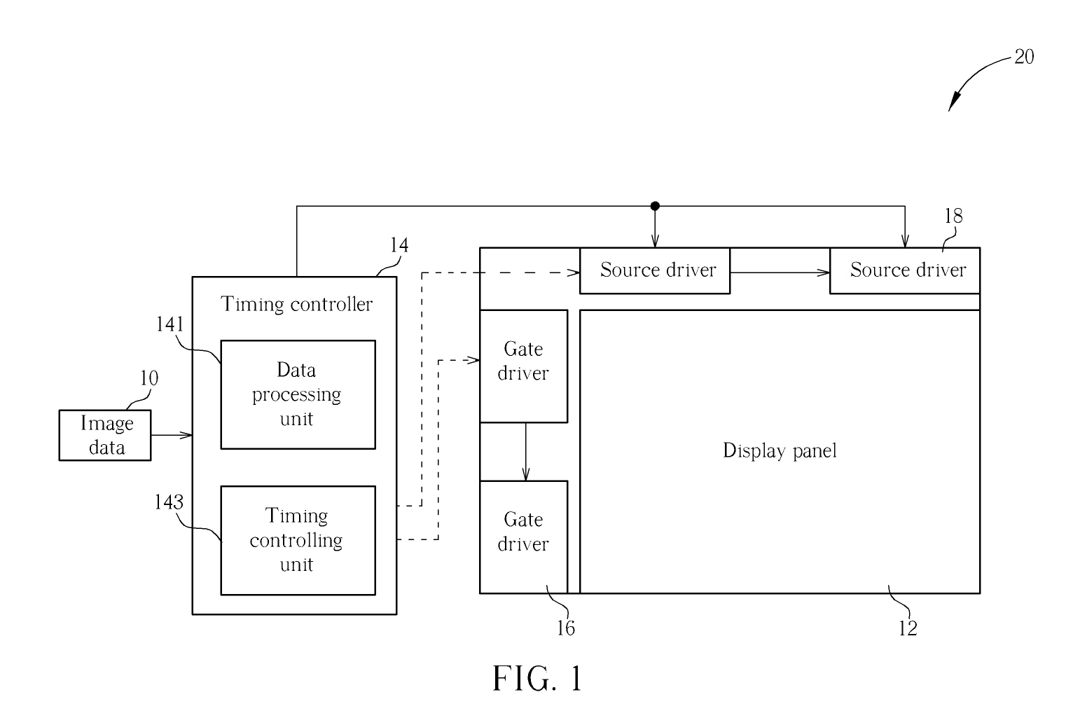

Please refer to FIG. 1. FIG. 1 is a diagram illustrating the Liquid Crystal Display (LCD) device 20 for reducing motion blur of the present invention. The LCD device 20 comprises a display panel 12, a timing controller 14, a gate driver 16 and a source driver 18. The timing controller 14 comprises a timing controlling unit 143 and a data processing unit 141. The timing controlling unit 143 is utilized to control the timing sequence for outputting the image data 10 to the gate driver 16 and the source driver 18. The data processing unit 141 is utilized to receive and process the image data 10, as well as transmitting the image data 10 to the source driver 18. The data processing unit 141 is able to insert the gray-level of black (or a different gray-level) into the frames of the image data 10, for achieving simulated impulse-type display mechanism to improve the motion blur of the LCD device accordingly. The simulated impulse-type display mechanism usually utilizes the concepts of visual persistence and visual averaged effect to insert the gray-level of black (or a different gray-level). By employing the concept of visual persistence the black frame insertion is equivalent as to insert gray-level of black (or a different gray-level) into different frames; that is, the gray-level is inserted according to different times. However, as mentioned above that if the frame rate is 60 Hz, the problem of the flicker arises. On the other hand, by employing the concept of visual averaged effect the black frame insertion is equivalent as to insert the gray-level of black (or a different gray-level) as different regions of the same frame and the combined gray-level can be perceived due to the visual averaged effect; that is, the gray-level is inserted according to different combinations of spaces. However, if the region of the inserted gray-level data is excessive, the displayed image of the corresponding frame is distorted. Therefore, the LCD device 20 according to the present invention utilizes the concepts of both visual persistence and visual averaged effect to insert black frames for improving the motion blur of the LCD device.

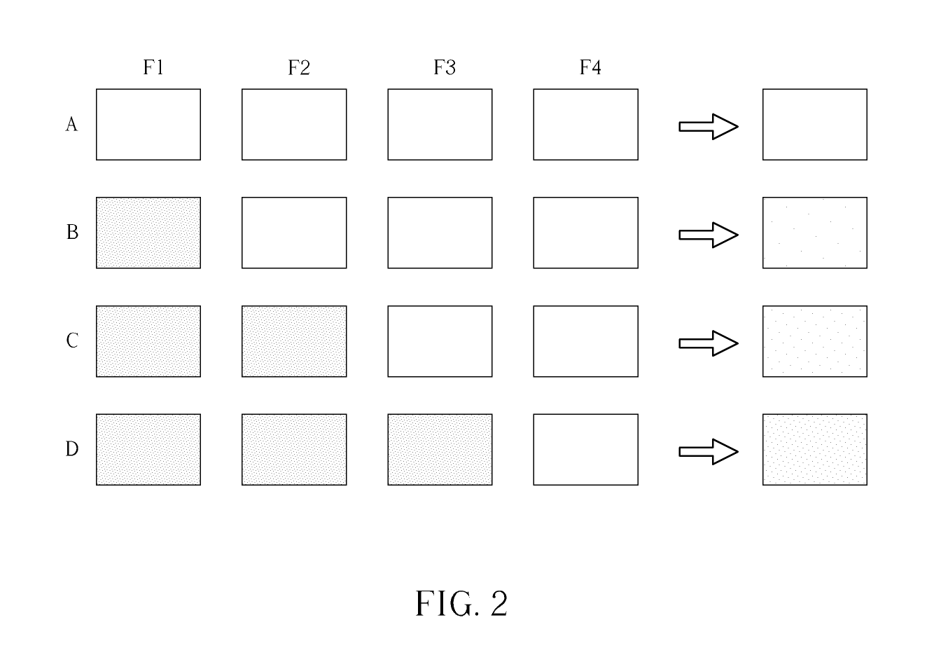

Please refer to FIG. 2. FIG. 2 is a diagram illustrating the generation of gray-level according to the concept of visual persistence. As shown in FIG. 2, during the period of four frames F1˜F4, each of the regions A, B, C, and D displays different gray-level. The region A displays the gray-level of white throughout frames F1˜F4, so the region A displays the gray-level of white. The region B displays the gray-level of black during the frame F1 and displays the gray-level of white during the frames F2˜F4, so the region B displays the gray-level of light gray. The region C displays the gray-level of black during the frames F1˜F2 and displays the gray-level of white during the frames F3˜F4, so the region C displays the gray-level of gray. The region D displays the gray-level of black during the frames F1˜F3 and displays the gray-level of white during the frame F4, so the region D displays the gray-level of dark gray.

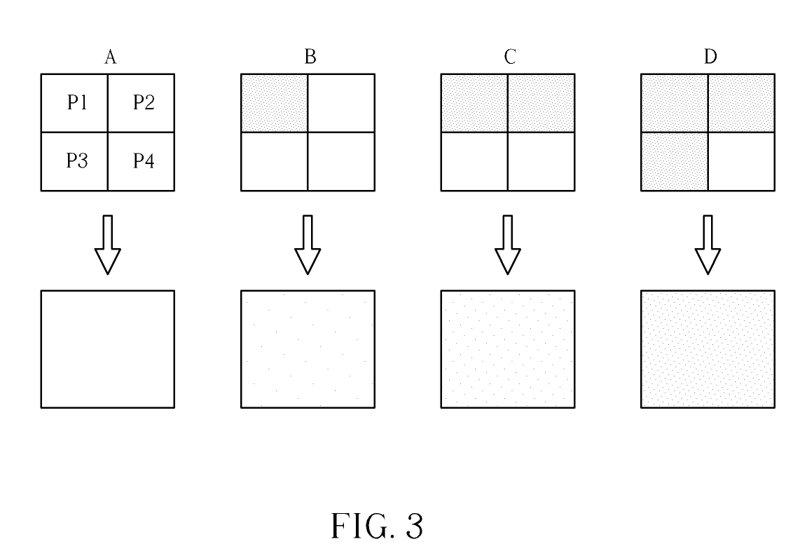

Please refer to FIG. 3. FIG. 3 is a diagram illustrating the generation of gray-level according to the concept of visual averaged effect. As shown in FIG. 3, each of the regions A, B, C and D comprises 4 pixels P1, P2, P3 and P4. The gray-level of the pixels P1˜P4 of the region A are all white, so the region A displays the gray-level of white. The gray-level of the pixel P1 of the region B is white and the gray-level of the pixels P2˜P4 of the region B are black, so the region B displays the gray-level of light gray. The gray-level of the pixels P1˜P2 of the region C are white and the gray-level of the pixels P3˜P4 of the region C are black, so the region C displays the gray-level of gray. The gray-level of the pixels P1˜P3 of the region D are white and the gray-level of the pixel P4 of the region D is black, so the region D displays the gray-level of dark gray.

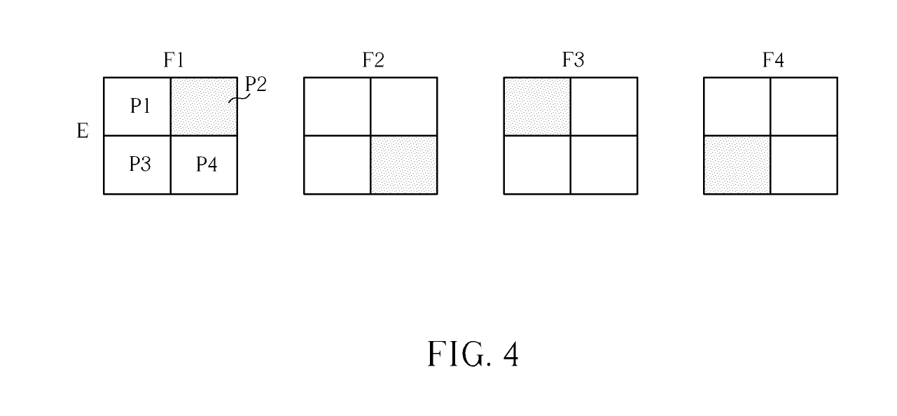

Please refer to FIG. 4. FIG. 4 is a diagram illustrating the LCD device 20 inserts the gray-level according to the first embodiment of the present invention. The LCD device 20 utilizes the concepts of both visual persistence and visual averaged effect to insert the black frame, so even the black frame is inserted into the frames with the frame rate of 60 Hz, the flicker is prevented. The region E comprises four pixels P1, P2, P3 and P4 where the gray-level of black is inserted into different pixels in frames F1˜F4. As shown in FIG. 4, during the frame F1, the gray-level of black is inserted into the pixel P2; during the frame F2, the gray-level of black is inserted into the pixel P4; during the frame F3, the gray-level of black is inserted into the pixel P1; during the frame F4, the gray-level of black is inserted into the pixel P3.

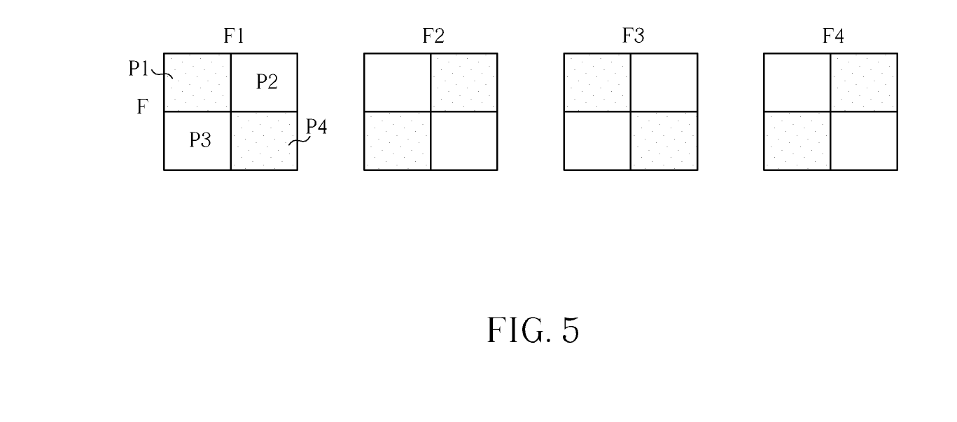

Please refer to FIG. 5. FIG. 5 is a diagram illustrating the LCD device 20 inserts the gray-level according to the second embodiment of the present invention. When the frame rate is maintained at 60 Hz, if the gray-level of black is inserted into the frame with a relatively high brightness, the flicker may be resulted due to the high contrast between the gray-levels (i.e. contrast between the inserted gray-level of black and the original gray-level of the frame) of the overall frame. Therefore to reduce the flicker caused by the gray-level contrast, according to the second embodiment of the present invention, the region F comprises 4 pixels P1, P2, P3 and P4 where the gray-level is inserted into two different pixels at once in frames F1˜F4 and the gray-level is inserted into two different pixels between each frame. However, instead of inserting the gray-level of black, a ½ gray-level of the original gray-level is inserted for maintaining most of the visual characteristics of the frame prior to the black frame insertion.

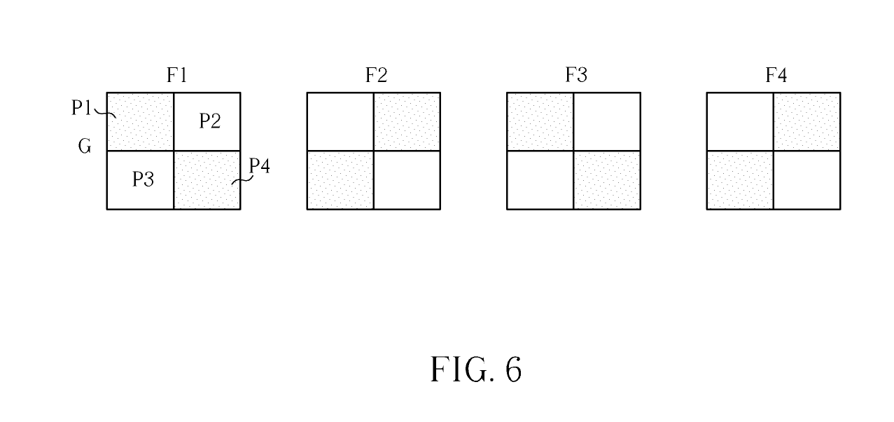

Please refer to FIG. 6. FIG. 6 is a diagram illustrating the LCD device 20 inserts the gray-level according to the third embodiment of the present invention. As shown in FIG. 6, the region G comprises 4 pixels P1, P2, P3 and P4 where the gray-level is inserted into two different pixels at once in frames F1˜F4 and the gray-level is inserted into two different pixels between each frame. In contrast to the second embodiment, the inserted gray-level is replaced from the gray-level of black to a predetermined gray-level. The black frame insertion using a predetermined gray-level can be performed together with the Over-Drive mode (OD mode), for reducing the memory usage required for recording the data of altering between different gray-levels being inserted. The usage of the display memory can then be reduced (i.e. ˜50% reduction). If the black frame insertion performed with the OD mode is applied to display panels with low resolution, the data can also be directly stored in the timing controller, eliminating the necessity of requiring the display memory.

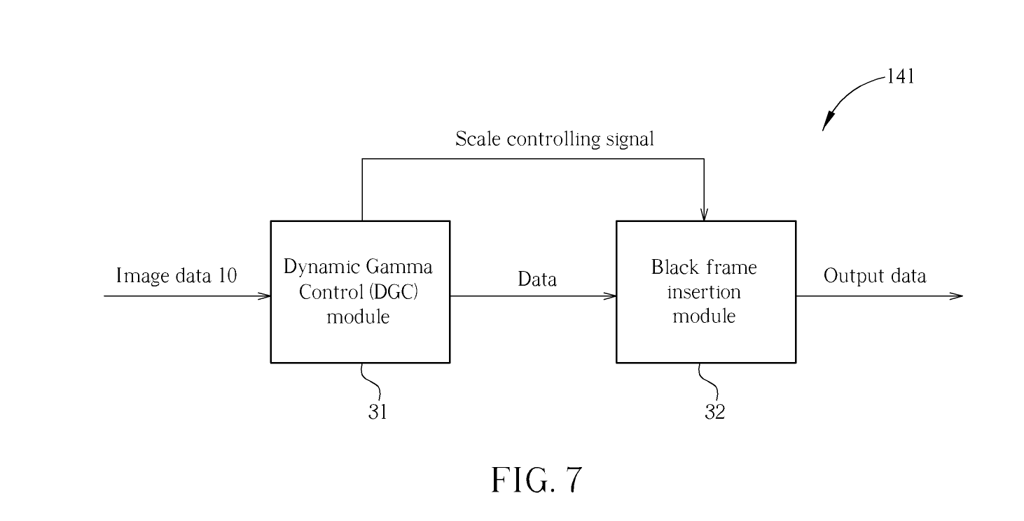

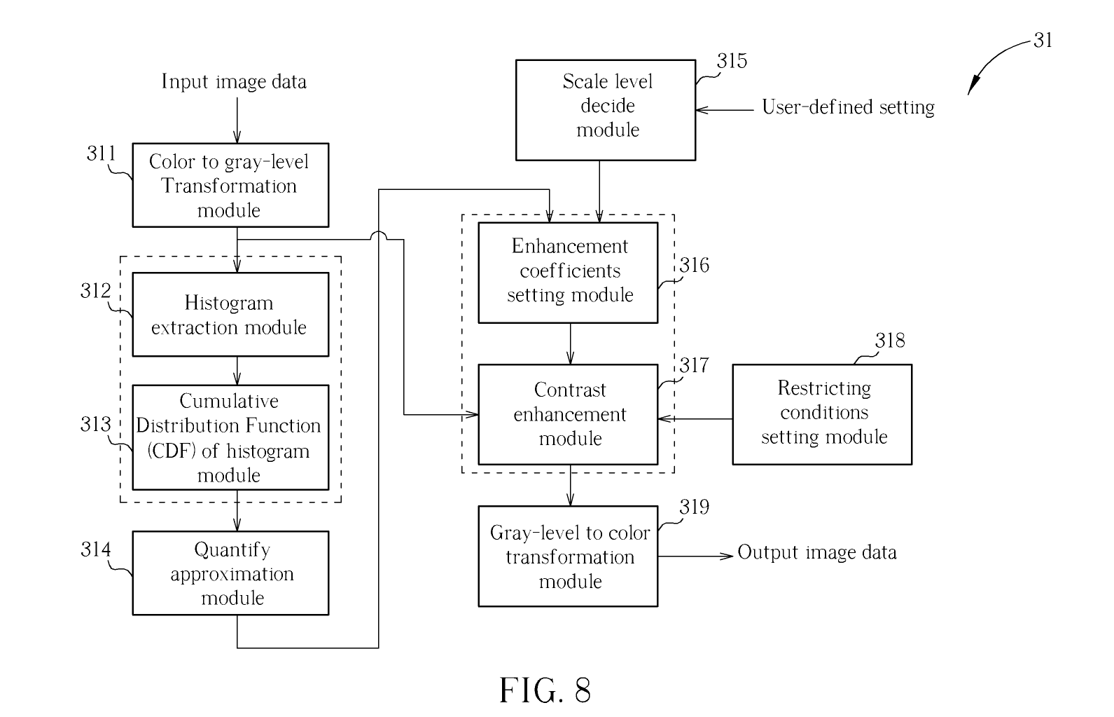

FIG. 7 and FIG. 8 together illustrate the fourth embodiment of the present invention. Please refer to FIG. 7, which illustrates the LCD device 20 with Dynamic Gamma Control (DGC) of the present invention. As shown in FIG. 7, the data processing unit 141 comprises a DGC module 31 and a black frame insertion module 32. The output data is generated from the image data 10 via the DGC module 31 and the black frame insertion module 32. The gray-level insertion value of the black frame insertion module 32 is generated according to the scale controlling signal generated from the DGC module 31. The scale controlling signal is inversely proportional to the gray-level insertion value (i.e. the larger the scale controlling signal, the lower the gray-level insertion value). The DGC module 31 is utilized to improve the display contrast, and to ease the impact of the low display brightness caused by the gray-level insertion.

Please refer to FIG. 8. FIG. 8 is a block diagram illustrating the DGC module 31. The DGC module 31 achieves analyzes the image data 10 for providing a better display contrast. The DGC module 31 comprises a color to gray-level transformation module 311, a histogram extraction module 312, a Cumulative Distribution Function (CDF) of histogram module 313, a quantify approximation module 314, a scale level decide module 315, an enhancement coefficients setting module 316, a contrast enhancement module 317, a restricting conditions setting module 318 and a gray-level to color transformation module 319. The color to gray-level transformation module 311 is utilized to convert the image data 10 from RGB to YUV format. The histogram extraction module 312 is utilized to calculate the probability density function (PDF) of Y data (i.e. the Y data from the YUV format) of the image. The CDF of histogram module 313 calculates a new curve plot according to the PDF of Y data of the image, and the curve plot represents the new enhanced Y transfer function. The quantify approximation module 314 is utilized to approximate the enhanced Y data for minimizing the usage of hardware circuit. The enhancement coefficients setting module 316 is influenced by three limitation factors; the first factor is the scale level decide module 315, which is user-defined and the other two limitation factors are beta and gamma. The factor beta is to prevent the excessive unevenness of the display contrast and brightness of a frame. The factor gamma is to determine the distribution of display contrast and brightness of a frame. The restricting conditions setting module 318 preserves the overall contrast of the frame (i.e. contrast restriction) and the gray-level to color transformation module 319 converts the image data back to RGB format for output.

In conclusion, the LCD device of the present invention utilizes the black frame insertion according to the combination of time and space, for reducing the motion blur of the LCD device. The LCD device comprises a display panel, a source driver, a gate driver, and a timing controller. The display panel includes a plurality of pixels for display an image data. The timing controller comprises a timing controlling unit and a data processing unit. The timing controlling unit controls the timing of the image data to be outputted to the source driver and the gate driver. The data processing unit analyzes the image data so as to insert the gray-level of black for the different pixels of the plurality of pixels in the different frames.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD) device for reducing motion blur, comprising:
a display panel, comprising a plurality of pixels, for displaying an image data;
a source driver, electrically connected to the display panel, for transmitting the image data;
a gate driver, electrically connected to the display panel, for driving the plurality of pixels to display the image data; and
a timing controller, comprising:
a timing controlling unit, for controlling a timing of the image data to be outputted to the gate driver and the source driver; and
a data processing unit, for analyzing the image data so as to insert a gray-level of black to different pixels of the plurality of pixels in different frames, the data processing unit comprising:
a black insertion module, for generating a gray-level of black to be inserted to the image data; and
a dynamic gamma control module, for generating a scale controlling signal to increase contrast of the image data so as to improve low brightness caused by inserting the gray-level to the image data, the gray level of black being determined by the scale controlling signal.

2. A display method for reducing motion blur, comprising:
providing a display panel which comprises a plurality of pixels, for displaying image data; and
utilizing a dynamic gamma control module to generate a scale controlling signal to increase contrast of the image data; and
inserting a gray-level of black to different pixels of the plurality of pixels in different frames, the gray level of black being determined by the scale controlling signal.
